(19) United States
(12) Patent Application Publication
(10) Pub. No.: US 2019/0018933 A1
(43) Pub. Date: Jan. 17, 2019

(54) SYSTEMS AND METHODS FOR MULTIMODAL GENERATIVE MACHINE LEARNING

(71) Applicant: Preferred Networks, Inc., Tokyo (JP)

(72) Inventors: Kenta Oono, Tokyo (JP); Justin Clayton, San Mateo, CA (US)

(21) Appl. No.: 16/070,276

(22) PCT Filed: Jan. 13, 2017
(86) PCT No.: PCT/JP2017/001034

§ 371 Date: Jul. 14, 2018

Related U.S. Application Data
(60) Provisional application No. 62/279,563, filed on Jan. 15, 2016.

(51) Int. Cl. G06F 19/00; G06N 7/08; G06N 3/04; G06F 19/24

(52) U.S. Cl. CPC G06F 19/707; G06F 19/24; G06N 3/0472; G06N 7/08

(57) ABSTRACT

In various embodiments, the systems and methods described herein relate to multimodal generative models. The generative models may be trained using machine learning approaches, using training sets comprising chemical compounds and one or more of biological, chemical, genetic, visual, or clinical information of various data modalities that relate to the chemical compounds. Deep learning architectures may be used. In various embodiments, the generative models are used to generate chemical compounds that satisfy multiple desired characteristics of different categories.

### TECHNICAL FIELD

This invention is concerning the multimodal generative machine learning.

### BACKGROUND ART

Exploration of lead compounds with desired properties typically comprises high throughput or virtual screening. These methods are slow, costly, and ineffective.

### SUMMARY OF INVENTION

### Technical Problem

In high throughput screening, chemical compounds from a compound library are tested. However, compound libraries are huge and most of the candidates are not eligible to be selected as a hit compound. To minimize costs associated with this complicated approach, some screening methods utilize in silico methods, known as virtual screening. However, available virtual screening methods require tremendous computational power and they can be algorithmically poor and time consuming.

Further, current hit-to-lead exploration primarily comprises exhaustive screening from vast lists of chemical compound candidates. This approach relies on the expectation and hope that a compound with a set of desired properties will be found within existing lists of chemical compounds. Further, even when current screening methods successfully find lead compounds, it does not mean that these lead compounds can be used as drugs. It is not rare for candidate compounds to fail at later stage of clinical trial. One of the major reasons of failure is toxicity or side effects that are not revealed until experiments with animals or humans. Finally, these exploration models are slow and costly.

Additionally, drug discovery is frequently conducted for a population of subjects without taking account the genetic make-up of individual sub-populations. Even where the genetic make-up is considered, the relevant genetic or biological marker may be needed for screening and/or testing. For example, personalized administration of Herceptin requires that a test for HER2 is relevant and the results of a HER2 test. These limitations confine personalized medical care, such as drug discovery to simple screenings of simple combinations of factors, where considerations of unknown or non-linear interactions of various factors is not enabled.

Because of the inefficiencies and limitations of existing methods, there is a need for drug design methods that directly generate candidate chemical compounds having the desired set of properties, such as binding to a target protein or being effective for a patient of a particular genetic make-up and for predicting how candidate chemical compounds would interact off-target and/or with other targets, lack toxicity or side effects. There is yet another need for generating values for genetic information where a candidate chemical compound is expected to induce specified results. There is a further need for personalized prescription methods. There is a final need for predictive models taking into account underlying distributions of high-dimensional multimodal data that can be trained on multiple modalities of data.

### Solution to Problem

In a first aspect, the systems and methods of the invention described herein relate to a computer system comprising a multimodal generative model. The multimodal generative model may comprise a first level comprising n network modules, each having a plurality of layers of units; and a second level comprising m layers of units. The generative model may be trained by inputting it training data comprising at least l different data modalities and wherein at least one data modality comprises chemical compound fingerprints. In some embodiments, at least one of the n network modules comprises an undirected graph, such as an undirected acyclical graph. In some embodiments, the undirected graph comprises a restricted Boltzmann machine (RBM) or deep Boltzmann machine (DBM). In some embodiments, at least one data modality comprises genetic information. In some embodiments, at least one data modality comprises test results or image. In some embodiments, a first layer of the second level is configured to receive input from a first inter-level layer of each of the n network modules. In some embodiments, a second inter-level layer of each of the n network modules is configured to receive input from a second layer of the second level. In some embodiments, the first layer of the second level and the second layer of the second level are the same. In some embodiments, the first inter-level layer of a network module and the second inter-level layer of a network module are the same. In some embodiments, n is at least 2, 3, 4, 5, 6, 7, 8, 9, 10, 15, 20, 25, 30, 35, 40, 45, 50, 60, 70, 80, 90, or 100. In some embodiments, m is at least 1, 2, 3, 4, or 5. In some embodiments, l is at least 2, 3, 4, 5, 6, 7, 8, 9, or 10. In some embodiments, the training data comprises a data type selected from the group consisting of genetic information, whole genome sequence, partial genome sequence, biomarker map, single nucleotide polymorphism (SNP), methylation pattern, structural information, translocation, deletion, substitution, inversion, insertion, viral sequence insertion, point mutation, single nucleotide insertion, single nucleotide deletion, single nucleotide substitution, microRNA sequence, microRNA mutation, microRNA expression level, chemical compound representation, fingerprint, bioassay result, gene expression level, mRNA expression level, protein expression level, small molecule production level, glycosylation, cell surface protein expression, cell surface peptide expression, change in genetic information, X-ray image, MR image, ultrasound image, CT image, photograph, micrograph, patient health history, patient demographic, patient self-report questionnaire, clinical notes, toxicity, cross-reactivity, pharmacokinetics, pharmacodynamics, bioavailability, solubility, disease progression, tumor size, changes of biomarkers over time, and personal health monitor data. In some embodiments, the generative model is configured to generate values for a chemical compound fingerprint upon input of genetic information and test results. In some embodiments, the generative model is configured to generate values for genetic information upon input of chemical compound fingerprint and test result. In some embodiments, the generative model is configured to generate values for test results upon input of chemical compound fingerprint and genetic information. In some embodiments, the generative model is configured to generate values for more than one data modality, for example, to generate values for missing elements of chemical compound fingerprints and missing elements of genetic information upon input of specified elements of chemical compound fingerprints and genetic information, as well as other data modalities such as test results, images, or sequential data measuring disease progression.

In a second aspect, the systems and methods of the invention described herein relate to a method for training a generative model, comprising inputting it training data comprising at least l different data modalities, at least one data modality comprising chemical compound fingerprints. The generative model may comprise a first level comprising n network modules, each having a plurality of layers of units. In some embodiments, the generative model also comprises a second level comprising m layers of units.

In a third aspect, the systems and methods of the invention described herein relate to a method of generating personalized drug prescription predictions. The method may comprise inputting to a generative model a value for genetic information and a fingerprint value for a chemical compound and generating a value for test results. The generative model may comprise a first level comprising n network modules, each having a plurality of layers of units; and a second level comprising m layers of units. The generative model may be trained by inputting it training data comprising at least l different data modalities, at least one data modality comprising chemical compound fingerprints, at least one data modality comprising test results, and at least one data modality comprising genetic information; and wherein the likelihood of a patient having genetic information of the input value to have the generated test results upon administration of the chemical compound is greater than or equal to a threshold likelihood. In some embodiments, the method further comprises producing for the patient a prescription comprising the chemical compound. In some embodiments, the threshold likelihood is at least 99%, 98%, 97%, 96%, 95%, 90%, 80%, 70%, 60%, 50%, 45%, 40%, 35%, 30%, 25%, 20%, 15%, 10%, 9%, 8%, 7%, 6%, 5%, 4%, 3%, 2%, 1%, 0.5%, or 0.1%.

In a third aspect, the systems and methods of the invention described herein relate to a method of personalized drug discovery. The method may comprise inputting to a generative model a test result value and a value for genetic information; and generating a fingerprint value for a chemical compound. The generative model may comprise a first level comprising n network modules, each having a plurality of layers of units; and a second level comprising m layers of units. The generative model may be trained by inputting it training data comprising at least l different data modalities, at least one data modality comprising chemical compound fingerprints, at least one data modality comprising test results, and at least one data modality comprising genetic information; and wherein the likelihood of a patient having genetic information of the input value to have the test results upon administration of the chemical compound is greater than or equal to a threshold likelihood. In some embodiments, the threshold likelihood is at least 99%, 98%, 97%, 96%, 95%, 90%, 80%, 70%, 60%, 50%, 45%, 40%, 35%, 30%, 25%, 20%, 15%, 10%, 9%, 8%, 7%, 6%, 5%, 4%, 3%, 2%, 1%, 0.5%, or 0.1%.

In a fourth aspect, the systems and methods of the invention described herein relate to a method of identifying patient populations for a drug. The method may comprise inputting to a generative model a test result value and a fingerprint value for a chemical compound; and generating a value for genetic information. The generative model may comprise a first level comprising n network modules, each having a plurality of layers of units and a second level comprising m layers of units. In some embodiments, the generative model is trained by inputting it training data comprising at least l different data modalities, at least one data modality comprising chemical compound fingerprints, at least one data modality comprising test results, and at least one data modality comprising genetic information; and wherein the likelihood of a patient having genetic information of the generated value to have the input test results upon administration of the chemical compound is greater than or equal to a threshold likelihood. In some embodiments, the threshold likelihood is at least 99%, 98%, 97%, 96%, 95%, 90%, 80%, 70%, 60%, 50%, 45%, 40%, 35%, 30%, 25%, 20%, 15%, 10%, 9%, 8%, 7%, 6%, 5%, 4%, 3%, 2%, 1%, 0.5%, or 0.1%. In some embodiments, the method further comprises conducting a clinical trial comprising a plurality of human subjects, wherein an administrator of the clinical trial has genetic information satisfying the generated value for genetic information for at least a threshold fraction of the plurality of human subjects. In some embodiments, the threshold fraction is at least at least 99%, 98%, 97%, 96%, 95%, 90%, 80%, 70%, 60%, 50%, 45%, 40%, 35%, 30%, 25%, 20%, 15%, 10%, 9%, 8%, 7%, 6%, 5%, 4%, 3%, 2%, 1%, 0.5%, or 0.1%.

In a fourth aspect, the systems and methods of the invention described herein relate to a method of conducting a clinical trial for a chemical compound. The method may comprise administering to a plurality of human subjects the chemical compound. In some embodiments, the administrator of the clinical trial has genetic information satisfying a generated value for genetic information for at least a threshold fraction of the plurality of human subjects and wherein the generated value for genetic information is generated according to the method of claim 23. In some embodiments, the threshold fraction is at least at least 99%, 98%, 97%, 96%, 95%, 90%, 80%, 70%, 60%, 50%, 45%, 40%, 35%, 30%, 25%, 20%, 15%, 10%, 9%, 8%, 7%, 6%, 5%, 4%, 3%, 2%, 1%, 0.5%, or 0.1%.

### BRIEF DESCRIPTION OF DRAWINGS

These and other aspects and features of the present invention will become apparent to those ordinarily skilled in the art upon review of the following description of specific embodiments of the invention in conjunction with the accompanying figures, wherein:

FIG. 1 illustrates an exemplary embodiment of the invention comprising a generative model having two levels, wherein the first level comprises two network modules each configured to accept a different data modality.

FIG. 2 illustrates another exemplary embodiment of the invention comprising a generative model having two levels, wherein the first level comprises four network modules each configured to accept a different data modality.

FIG. 3 illustrates another exemplary embodiment of the invention comprising a generative model having three levels, wherein the joint representation of two network modules in the 0^{th} level and the output of the network modules in the first level are combined in a second joint representation in the second level.

FIG. 4 is a block diagram of an exemplary computer system that may perform one or more of the operations described herein.

FIG. 5 illustrates an exemplary embodiment of the invention comprising a generative model having two levels configured to generate values for elements of two different data modalities.

FIG. 6 illustrates an exemplary embodiment of the invention comprising a multimodal generative model comprising a variational recurrent neural network (VRNN).

FIG. 7 illustrates data flow for components of an exemplary VRNN.

### DESCRIPTION OF EMBODIMENTS

In various embodiments, the systems and methods of the invention relate to generative models for precision and/or personalized medicine. The generative models may incorporate and/or be trained using multiple data modalities such as a plurality of data modalities comprising genetic information, such as whole or partial genome sequences, biomarker maps, single nucleotide polymorphisms (SNPs), methylation patterns, structural information, such as translocations, deletions, substitutions, inversions, insertions, such as viral sequence insertions, point mutations, such as insertions, deletions, or substitutions, or representations thereof, microRNA sequences, mutations and/or expression levels; chemical compound representations, e.g. fingerprints; bioassay results, such as expression levels, for example gene, mRNA, protein, or small molecule expression/production levels in healthy and/or diseased tissues, glycosylation, cell surface protein/peptide expression, or changes in genetic information; images, such as those obtained by non-invasive (e.g. x-ray, MR, ultrasound, CT, etc.) or invasive (e.g. biopsy images, such as photographs or micrographs) procedures, patient health history & demographics, patient self-report questionnaires, and/or clinical notes, including notes in the form of text; toxicity; cross-reactivity; pharmacokinetics; pharmacodynamics; bioavailability; solubility; disease progression; tumor size; changes of biomarkers over time; personal health monitor data; and any other suitable data modality or type known in the art. Such systems can be used to generate output of one or more desired data modalities or types. Such systems and methods may take as input values of one or more data modalities in order to generate output of one or more desired data types.

In various embodiments, the systems and methods described herein can be used to recognize and utilize non-linear relationships between various data modalities. Such non-linear relationships may relate to varying degrees of abstraction in the representation of relevant data modalities.

In some embodiments, the methods and systems of the invention can be used for various purposes described in further detail herein, without requiring known biomarkers. Systems and methods described herein may involve modules and functionalities, including, but not limited to, masking modules allowing for handling inputs of varying size and/or missing values in training and/or input data. The systems and methods described herein may comprise dedicated network modules, such as restricted Boltzmann machines (RBMs), deep Boltzmann machines (DBMs), variational autoencoders (VAEs), recurrent neural networks (RNNs), or variational recurrent neural networks (VRNNs), for one or more data modalities.

In various embodiments, the methods and systems described herein comprise a multimodal generative model, such as a multimodal DBM or a multimodal deep belief net (DBN). A multimodal generative model, such as a multimodal DBM may comprise a composition of unimodal pathways, such as directed or undirected unimodal pathways. Each pathway may be pretrained separately in a completely unsupervised or semi-supervised fashion. Alternatively, the entire network of all pathways and modules may be trained together. Any number of pathways, each with any number of layers may be used. In some embodiments, the transfer function for the visible and hidden layers is different within a pathway and/or between pathways. In some embodiments, the transfer function for the hidden layers at the end of each pathway is the same type, for example binary. The differences in statistical properties of the individual data modalities may be bridged by layers of hidden units between the modalities. The generative models described herein may be configured such that states of low-level hidden units in a pathway may influence the states of hidden units in other pathways through the higher-level layers.

A generative model may comprise about or more than about 1, 2, 3, 4, 5, 6, 7, 8, 9, or more levels. In some embodiments, the generative model comprises about or less than about 10, 9, 8, 7, 6, 5, 4, or 3 levels. Each level may comprise one or more network modules, such as a RBM or DBM. For example, a level, such as a first level, a second level, a third level, or another level, may comprise about or more than about 2, 3, 4, 5, 6, 7, 8, 9, 10, 11, 12, 13, 14, 15, 16, 17, 18, 19, 20, 25, 30, 35, 40, 45, 50, 55, 60, 65, 70, 80, 90, 100, or more network modules. In some embodiments, a level may comprise about or less than about 200, 150, 125, 100, 90, 80, 70, 65, 60, 55, 50, 45, 40, 35, 30, 25, 20, 19, 18, 17, 16, 15, 14, 13, 12, 11, 10, 9, 8, 7, 6, 5, 4, or 3 network modules. Each network module may be used to generate a representation for data of a particular data modality or type. The data modality or type may be genetic information, such as whole or partial genome sequences, biomarker maps, single nucleotide polymorphisms (SNPs), methylation patterns, structural information, such as translocations, deletions, substitutions, inversions, insertions, such as viral sequence insertions, point mutations, such as insertions, deletions, or substitutions, or representations thereof, microRNA sequences, mutations and/or expression levels; chemical compound representations, e.g. fingerprints; bioassay results, such as expression levels, for example gene, mRNA, protein, or small molecule expression/production levels in healthy and/or diseased tissues, glycosylation, cell surface protein/peptide expression, or changes in genetic information; images, such as those obtained by non-invasive (e.g. x-ray, MR, ultrasound, CT, etc.) or invasive (e.g. biopsy images, such as photographs or micrographs) procedures, patient health history & demographics, patient self-report questionnaires, and/or clinical notes, including notes in the form of text; toxicity; cross-reactivity; pharmacokinetics; pharmacodynamics; bioavailability; solubility; disease progression; tumor size; changes of biomarkers over time; personal health monitor data and any other suitable data modality or type known in the art. A second or later level may be used for a joint representation incorporating representations from the first level. The level that is used for the joint representation may comprise more than one hidden layer and/or another type of model, such as a generative, for example a variational autoencoder.

In various embodiments, the methods and systems of the method may be trained to learn a joint density model over the space of data comprising multiple modalities. The generative models maybe used to generate conditional distributions over data modalities. The generative models may be used to sample from such conditional distributions to generate label element values in response to input comprising values for other label elements. In some embodiments, e.g. for seeding, the generative models may sample from such conditional distributions to generate label element values in response to input comprising values for label elements, including a value for the generated label element.

The generated values described herein in various embodiments may satisfy a threshold condition of success. In some embodiments, threshold conditions are expressed in terms of likelihood of satisfying a desired label or label element value.

In various embodiments, the methods and systems described herein may be used for training a generative model, generating representations of chemical compounds and/or associated label values, or both. A generation phase may follow the training phase. In some embodiments, a first party performs the training phase and a second party performs the generation phase. The party performing the training phase may enable replication of the trained generative model by providing parameters of the system that are determined by the training to a separate computer system under the possession of the first party or to a second party and/or to a computer system under the possession of the second party, directly or indirectly, such as by using an intermediary party. Therefore, a trained computer system, as described herein, may refer to a second computer system configured by providing to it parameters obtained by training a first computer system using the training methods described herein such that the second computer system is capable of reproducing the output distribution of the first system. Such parameters may be transferred to the second computer system in tangible or intangible form.

The network modules, such as network modules in a first level of a generative model, in various embodiments, are configured according to the specific data modality or type for which the module is set to generate representations. Units in any layer of any level may be configured with different transfer functions. For example, visible and hidden units taking binary values may use binary or logistic transfer functions. Real valued visible units may use Gaussian transfer functions. Images may be represented by real valued data, for which real-valued visible units are suitable. Gaussian-Bernoulli RBMs or DBMs may be used for real-valued visible and binary hidden units. Ordinal valued data may be encoded using cumulative RBMs or DBMs. When input is of mixed types, mixed-variate RBMs or DBMs may be used. Text may be encoded by Replicated Softmax alone or in combination with additional network modules. Genetic sequences may be encoded by recurrent neural networks (RNNs), for example by RNNs of variational autoencoders (VAEs).

In various embodiments, the generative models are constructed and trained such that the representations for individual modalities or data types are influenced by representations from one or more of the other data modalities or data types. The representations for individual modalities or data types may also be influenced by a joint representation incorporating representations from multiple network modules.

In some embodiments, a network generates both identifying information for a specific medication or drug, for example values for some or all elements of a fingerprint and a recommended dose, for example a recommended dose in the form of a continuous variable.

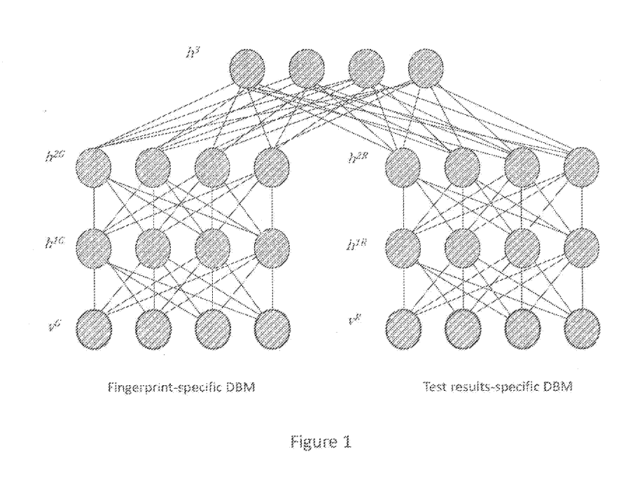

FIG. 1 illustrates an exemplary embodiment of the invention comprising a generative model having two levels. The first level may comprise two or more network modules configured to be dedicated to specific data modalities or types. For example, a first network module may comprise a fingerprint-specific RBM or DBM. A second module may comprise a RBM or DBM specific to in vitro or in vivo test results for a chemical compound, e.g. gene expression data. The network modules in the first level may be linked in the second level comprising one or more layers of units. The layers of the second level may comprise hidden units. In some embodiments, the second level comprises a single hidden layer. The layers of the second level may incorporate the output from the modules in the first level in a joint representation. A joint probability distribution may reflect the contributions from several modalities or types of data.

Systems and methods comprising generative models for chemical compound fingerprints and associated label data, for example label data having chemical compound associated bioassay results are described in numerous embodiments in U.S. Pat. App. No. 62/262,337, which is herein incorporated by reference in its entirety. The exemplary embodiment illustrated in FIG. 1, also allows for a generative model that links chemical compound fingerprints to chemical compound associated results, i.e., a generative model for generating assay results from chemical compound fingerprints and/or for generating chemical compound fingerprints from desired results.

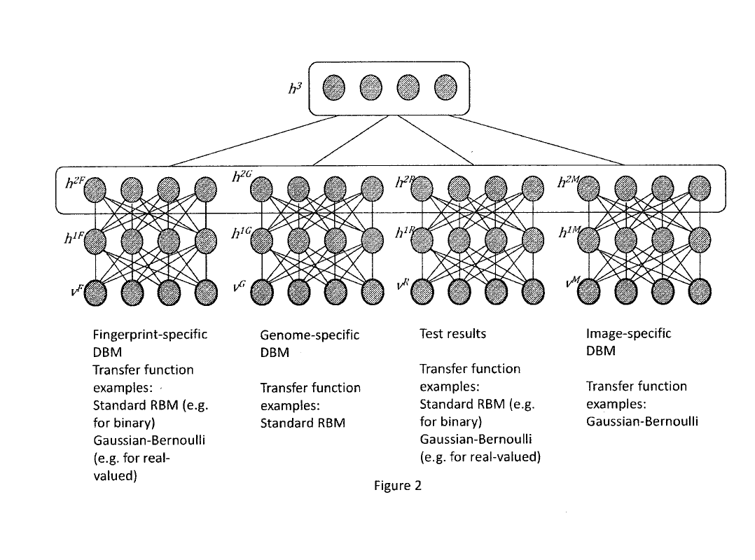

FIG. 2 illustrates another exemplary embodiment of the invention comprising a generative model having two levels. The first level may comprise two or more network modules configured to be dedicated to specific data modalities or types. For example, a first network module may comprise a fingerprint-specific RBM or DBM. A second module may comprise a RBM or DBM specific for genetic information. A third module may comprise a RBM or DBM specific for in vitro or in vivo test results for a chemical compound, e.g. gene expression data. A fourth module may comprise a RBM or DBM specific for image data. The image data may comprise one or more image types, such as X-ray, ultrasound, magnetic resonance (MR), computerized tomography (CT), biopsy photographs or micrographs, or any other suitable image known in the art. The network modules in the first level may be linked in the second level comprising one or more layers of units. The layers of the second level may comprise hidden units. In some embodiments, the second level comprises a single hidden layer. In some embodiments, the second level may comprise a generative model, such as a variational autoencoder. The layers of the second level may incorporate the output from the modules in the first level in a joint representation. A joint probability distribution may reflect the contributions from several modalities or types of data.

In some embodiments, the systems and methods of the invention described in further detail herein, provide that the individual modules in the first level, such as individual RBMs or DBMs, are trained simultaneously with the one or more hidden layers in the second level. Without being bound by theory, simultaneous training may allow for the joint representation to influence the trained weights in the individual network modules. Further without being bound by theory, the joint representation may therefore influence the encoding of individual data modalities or types in each network module, such as a RBM or DBM. In some embodiments, one or more network modules in the first level encode a single-variable.

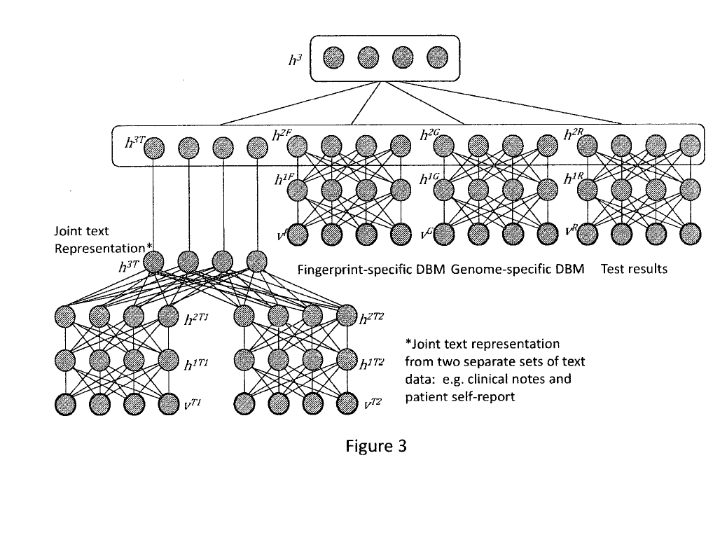

In various embodiments, the systems and methods of the invention provide for a plurality of network modules from a first level to be joined in a second level. The individual network modules in the first level may have same or similar architectures. In some embodiments, the architectures of individual network modules within a first layer differ from each other. The individual network modules may be configured to account for differences in the encoding of different types of data modalities or types. In some embodiments, separate network modules may be dedicated to encode different data types having similar data modalities. For example, two data types of text modality, such as clinical notes and patient self-report surveys, may be encoded using two separate network modules (FIG. 3).

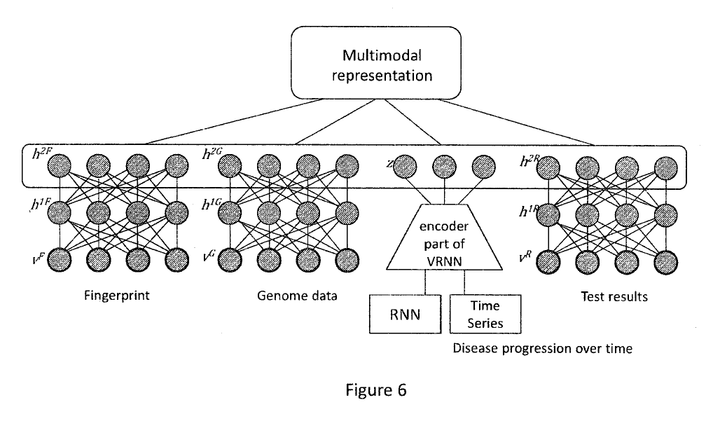

FIG. 6 illustrates an exemplary embodiment of the invention comprising a multimodal generative model comprising a VRNN. The encoder of the VRNN may be used to generate a latent representation, z, of a time series at every time step. The encoding at time t may take into account temporal information of the time series. The RNN may update its hidden state at every step from the new data point and the latent representation from the VAE at the previous time step.

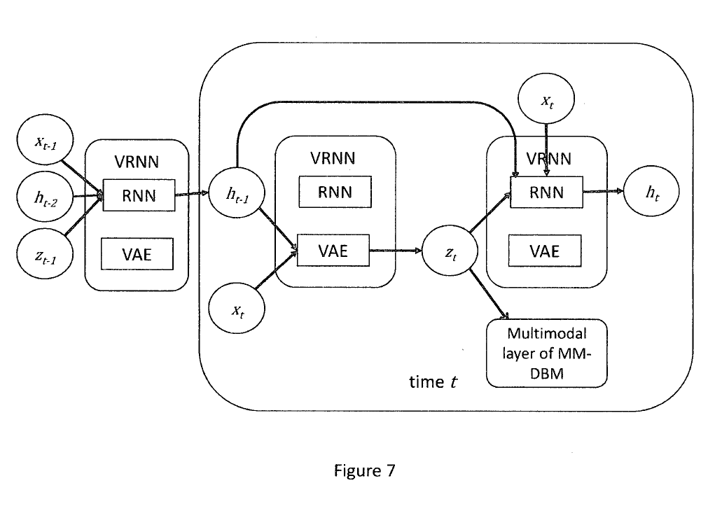

FIG. 7 illustrates data flow for components of an exemplary VRNN, where xₜ. zₜ, hₜ are data point of time series at time t, latent representation of time series at t, and hidden state of RNN, respectively.

In some embodiments, network modules may be configured within additional levels of model architecture. Such additional levels may input representations into a first, a second, or another level of architecture described in further detail elsewhere herein. For example, data may be encoded in a “0^{th}” level and the resulting representation may be input into the first level, for example a specific network module within the first level or directly into the second level. The training of the network modules in additional levels of architecture may or may not be performed simultaneously with the network modules from other levels.

In various embodiments, the systems and methods described herein utilize deep network architectures, including but not limited to deep generative models, DBMs, DBNs, probabilistic autoencoders, recurrent neural networks, variational autoencoders, recurrent variational networks, variational recurrent neural networks (VRNNs), undirected or directed graphical models, belief networks, or variations thereof.

<Data>

In various embodiments, the systems and methods described herein are configured to operate in a multimodal setting, wherein data comprises multiple modes. Each modality may have a different kind of representation and correlational structure. For example, text may be usually represented as discrete sparse word count vectors. An image may be represented using pixel intensities or outputs of feature extractors which may be real-valued and dense. The various modes of data may have very different statistical properties. Chemical compounds may be represented using fingerprints. The systems and methods described herein, in various embodiments, are configured to discover relationships across modalities, i.e., inter-modality relationships, and/or relationships among features in the same modality, i.e., intra-modality relationships. The systems and methods described herein may be used to discover highly non-linear relationships between features across different modalities. Such features may comprise high or low level features. The systems and methods described herein may be equipped to handle noisy data and data comprising missing values for certain data modalities or types.

In some embodiments, data comprise sequential data, such as changes in biomarkers over time, tumor size over time, disease progression over time, or personal health monitor data over time.

The systems and methods of the invention described in further detail elsewhere herein, in various embodiments, may be configured to encode one or more data modalities, such as about or at least about 2, 3, 4, 5, 6, 7, 8, 9, 10, 11, 12, 13, 14, 15, 16, 17, 18, 19, or more data modalities. Such data modalities may include, chemical compound representations, such as finger prints, genetic information, test results, image data or any other suitable data described in further detail herein or otherwise known in the art.

<Sources of Data>

The training data may be compiled from information of chemical compounds and associated labels from databases, such as PubChem (http://pubchem.ncbi.nlm.nih.gov/). The data may also be obtained from drug screening libraries, combinatorial synthesis libraries, and the like. Test result label elements that relate to assays may comprise cellular and biochemical assays and in some cases multiple related assays, for example assays for different families of an enzyme. In various embodiments, information about one or more label elements may be obtained from resources such as chemical compound databases, bioassay databases, toxicity databases, clinical records, cross-reactivity records, or any other suitable database known in the art.

Genetic information may be obtained from patients directly or from databases, such as genomic and phenotype variation databases, the Cancer Genome Atlas (TCGA) databases, genomic variation databases, variant-disease association databases, clinical genomic databases, disease-specific variation databases, locus-specific variation databases, somatic cancer variation databases, mitochondrial variation databases, national and ethnic variation databases, non-human variation databases, chromosomal rearrangement and fusion databases, variation ontologies, personal genomic databases, exon-intron databases, conserver or ultraconserved coding and non-coding sequence databases, epigenomic databases, for example databases for DNA methylation, histone modifications, nucleosome positioning, or genome structure, or any other suitable database known in the art.

In some embodiments, genetic information is obtained from tissues or cells, such as stem cells, for example induced pluripotent stem cells (iPS cells or iPSCs) or populations thereof. Genetic information may be linked to other types of data including but not limited to response to administration of one or more chemical compound(s), clinical information, self-reported information, image data, or any other suitable data described herein or otherwise known in the art.

MicroRNA information may be obtained from subjects trying a chemical compound, from tissues or cells, such as stem cells, alone or in combination with information from a microRNA and/or a microRNA target database, such deepBase (biocenter.sysu.edu.cn/deepBase/), miRBase (www.mirbase.org/), microRNA.org (www.microrna.org/microrna/getExprForm.do), miRGen (carolina.imis.athena-innovation.gr/index.php?=mirgenv3), miRNAMap (mirnamap.mbc.nctu.edu.tw/), PMRD (bioinformatics.cau.edu.cn/PMRD/), TargetScan (www.targetscan.org/), StarBase (starbase.sysu.edu.cn/), StarScan (mirlab.sysu.edu.cn/starscan/), Cupid (cupidtool.sourceforge.net/), TargetScan (www.targetscan.org/), TarBase (diana.imis.athena-innovation.gr/DianaTools/index.php?r=tarbase/index), Diana-micro T (diana.imis.athena-innovation.gr/DianaTools/index.php?r=microtv4/index), miRecords (c1.accurascience.com/miRecords/), Pic Tar (pictar.mdc-berlin.de/), PITA (genie.weizmann.ac.il/pubs/mir07/mir07_data.html), RepTar (reptar.ekmd.huji.ac.il/), RNA22 (cm.jefferson.edu/rna22/), miRTarBase (mirtarbase.mbc.nctu.edu.tw/), miRwalk (www.umm.uni-heidelberg.de/apps/zmf/mirwalk/), or MBSTAR (www.isical.ac.in/˜bioinfo_miu/MBStar30.htm).

<Generation>

In various embodiments, the systems and methods described herein utilize a generative model as a core component. Generative models, according to the methods and systems of the invention, can be used to randomly generate observable-data values given values of one or more visual or hidden variables. The visual or hidden variables may be of varying data modalities or types described in further detail elsewhere herein. Generative models can be used for modeling data directly (i.e., modeling chemical compound observations drawn from a probability density function) and/or as an intermediate step to forming a conditional probability density function. Generative models described in further detail elsewhere herein typically specify a joint probability distribution over chemical compound representations, e.g., fingerprints, and other data associated with the compounds.

The systems and methods described herein, in various embodiments, may be configured to learn a joint density model over the space of multimodal inputs or multiple data types. Examples for the data types are described in further detail elsewhere herein and may include, but are not limited to chemical compound fingerprints, genetic information, test results, text based data, images etc. Modalities having missing values may be generatively filled, for example using trained generative models, such as by sampling from the conditional distributions over the missing modality given input values. The input values may be for another modality and/or for elements of the same modality as the modality of the missing values. For example, a generative model may be trained to learn a joint distribution over chemical compound fingerprints and genetic information P(v^{F}, v^{G}; θ), where v^{F} denotes chemical compound fingerprints, v^{G} denotes genetic information, and θ denotes the parameters of the joint distribution. The generative model may be used to draw samples from P(v^{F}|v^{G}; θ) and/or from P(v^{F}|v^{G}; θ). Missing values for either data modality may thus be generated using the systems and methods described herein.

In some embodiments, generative methods use input values for fewer modalities of data than the number of modalities used to train the generative model.

In various embodiments, the generative models described herein comprise RBMs or DBMs. In some embodiments, RBMs and DBMs learn to reconstruct data in a supervised or unsupervised fashion. The generative models may make one or more forward and backward passes between a visible layer and one or more hidden layer(s). In the reconstruction phase, the activations of a hidden layer may become the input for the layer below in a backward pass.

As an example, a set of chemical compounds may be represented as F=(f₁, f₂ . . . . , f_{K}), where fᵢ may comprise a fingerprint representation of a compound and K is the number of compounds in the set. These compounds may be associated with a set of M test result labels R=(r₁, r₂, . . . , r_{M}), where rᵢ is a result label that may comprise, for example, values for label elements such as gene expression levels in healthy and/or diseased tissues, tRNA information, compound activity, toxicity, solubility, ease of synthesis, or other outcomes in bioassay results or predictive studies, with a set of N genetic information labels G=(g₁, g₂, . . . , g_{N}), with a set of Q image labels M=(m₁, m₂, . . . , m_{Q}), with a set of S text labels T=(t₁, t₂, . . . , t_{S}), and/or with sets of U other labels O=(o₁, o₂, . . . , o_{U}) of suitable types that are associated with the chemical compound described in further detail elsewhere herein or otherwise known in the art. In some embodiments, each type of label is input into an individual network module. In some cases, an individual type of label may be pre-processed and/or broken down to sub-labels. For example, an imaging label may comprise photograph, micrograph, MR scan sub-labels or genomic data may comprise partial genome sequences, SNP maps, etc. Sub-labels may be pre-processed and/or input into different network modules.

A generative model may be built upon the assumption that these chemical compounds and the associated data are generated from some unknown distribution D, i.e. D˜(fₙ, rₙ, gₙ, mₙ, tₙ, oₙ). Training a generative model may utilize a training methodology that adjusts the model's internal parameters such that it models the joint probability distribution P(f, r, g, m, t, o) from the data examples in the training data set. All or a subset of the various data types of labels may be input to the systems and methods described herein. In some embodiments, the generative models may be trained with more types of data labels than are used in a generation procedure. The distribution D and the joint probability distribution may be defined taking into account the types of input labels.

After a generative model has been trained, it may be used to generate values of f conditioned on values of r, g, m, t, and/or o, i.e., f˜p(f|r, g, m, t, o). For example, a generative model trained on a training set of fingerprints and various types of labels may generate a representation of a chemical compound that has a high likelihood of meeting the requirements of a specified label value. In this way, the systems and methods of the invention, in various embodiments, may be used for personalized drug discovery. For example, given a patient's genetic information label G′ and a desired results label R′, fingerprints of chemical compounds may be generated using the systems and methods described herein. Such chemical compounds may serve as candidate drugs having a likelihood of satisfying R′ for that patient, where such likelihood is greater than or greater than equal to a threshold likelihood. In some embodiments, the systems and methods of the invention may be used to generate a plurality of fingerprints, such as about or at least about 2, 3, 4, 5, 6, 7, 8, 9, 10, 11, 12, 13, 14, 15, 20, 25, 30, 35, 40, 45, 50, 60, 70, 80, 90, 100, 125, 150, 175, 200, 250, 300, 400, 500, or more fingerprints, for chemical compounds, where at least 1, 2, 3, 4, 5, 6, 7, 8, 9, 10, or more of the chemical compounds have a likelihood above a threshold likelihood of satisfying R′. In various embodiments, a threshold likelihood may be set as 99%, 98%, 97%, 96%, 95%, 90%, 80%, 70%, 60%, 50%, 45%, 40%, 35%, 30%, 25%, 20%, 15%, 10%, 9%, 8%, 7%, 6%, 5%, 4%, 3%, 2%, 1%, 0.5%, 0.1%, or less.

In some embodiments, a trained generative model may be used to generate values of a particular type of label l or elements thereof, such as values for r, g, m, t, o, and/or elements thereof, conditioned on values of one or more other labels l, i.e. r, g, m, t, o, and/or elements thereof, and/or values of for elements thereof, i.e., lₙ˜p(l|f,lₙ₊₁). For example, a generative model trained on a training set of fingerprints and various types of labels may generate a representation of a test result with a high likelihood of being true. In this way, the systems and methods of the invention, in various embodiments, may be used for personalized drug prescription. For example, given a chemical compound's fingerprint F′ and a patient's genetic information label G′, values of a test result label R′ may be generated using the systems and methods described herein. Alternatively, genetic information G′, including but not limited to whole or partial genome sequences or biomarkers, that may be correlated with a certain result and/or a certain drug may be identified using the methods and systems described herein. For example, given a chemical compound's fingerprint F′ and values of a label, such as a result label R′, a patient's genetic information label G′ may be generated using the systems and methods described herein. The systems and methods of the invention, in various embodiments, can be used to identify a set of genetic characteristics G′ for which a specified chemical compound is most likely to be effective. In some embodiments, the systems and methods of the invention are used to identify patient populations for prescribing, clinical trials, second uses etc. both for desired indications and side effects. Components of genetic information that are most likely to be correlated with a chemical compound and specified results may be identified using the systems and methods described herein. Patients may be tested prior to prescription for satisfying the genetic information criteria picked by the methods and systems for a given chemical compound and specified results. In some embodiments, the systems and methods of the invention are used to predict the efficacy of a drug for a patient by inputting patient-specific data, such as genetic information, imaging data, etc. Generated labels comprising continuous values may be ranked.

In various embodiments, generated values have a likelihood of being associated with the input values, for example input values of a chemical compound fingerprint, a result and/or genetic information, where such likelihood is greater than or greater than equal to a threshold likelihood. In some embodiments, the systems and methods of the invention may be used to generate a plurality of values or a range of values for a generated label, such as about or at least about 2, 3, 4, 5, 6, 7, 8, 9, 10, 11, 12, 13, 14, 15, 20, 25, 30, 35, 40, 45, 50, 60, 70, 80, 90, 100, 125, 150, 175, 200, 250, 300, 400, 500, or more values or value ranges, where one or more of the individual values or value ranges are assigned a likelihood of being true, given the input. Assigned likelihoods may be compared to threshold likelihoods to tailor a further processed output. Generation of a label value may be repeated. For example, n iterations of the generation process may be performed, where n is about or at least about 2, 3, 4, 5, 6, 7, 8, 9, 10, 11, 12, 13, 14, 15, 20, 25, 30, 35, 40, 45, 50, 60, 70, 80, 90, 100, 125, 150, 175, 200, 250, 300, 400, 500, or more. In some cases, n is less than about 500, 400, 300, 250, 200, 175, 150, 125, 100, 90, 80, 70, 60, 50, 45, 40, 35, 30, 25, 20, 15, 14, 13, 12, 11, 10, 9, 8, 7, 6, 5, 4, or 3. The likelihood of a particular value for a generated label may be determined by the plurality of outputs from multiple generation processes. In various embodiments, a threshold likelihood may be set as 99%, 98%, 97%, 96%, 95%, 90%, 80%, 70%, 60%, 50%, 45%, 40%, 35%, 30%, 25%, 20%, 15%, 10%, 9%, 8%, 7%, 6%, 5%, 4%, 3%, 2%, 1%, 0.5%, 0.1%, or less.

A trained generative model, such as a RBM, a DBM, or a multimodal DBM, may be used to generate or simulate observable-data values by sampling from a modeled joint probability distribution to generate values or value ranges for a label.

In one embodiment, the weights of the generative model or individual modules therein are adjusted during training by an optimization method.

In various embodiments, the generative models described herein are configured to handle missing values for visible variables. A missing value may be handled, for example by Gibbs sampling or by using separate network modules, such as RBMs or DBMs with different numbers of visible units for different training cases. Gibbs sampling methods may compute the free energy for each possible value of a label l or label element and then pick value(s) with probability proportional to exp(−F(l, v)), wherein F is the free energy of a visible vector. The free energy F may be denoted by

$${e}^{- F ( v )} = {\sum }_{h} {e}^{- E ( v , h )} \qquad [ Math . 1 ]$$

another useful expression, such as

$$F ( v ) = - {\sum }_{i} {v}_{i} {a}_{i} - {\sum }_{j} log ( 1 + {e}^{{x}_{i}} ) \qquad [ Math . 2 ]$$

or the expected energy minus the entropy

$$\begin{matrix}F ( v ) = - {\sum }_{i} {v}_{i} {a}_{i} - {\sum }_{j} {p}_{j} {x}_{j} + {\sum }_{j} ( {p}_{j} log {p}_{j} + ( 1 - {p}_{j} ) log ( 1 - {p}_{j} ) ) \\ where & [ Math . 3 ] \\ {x}_{j} = {b}_{j} + {\sum }_{i} {v}_{i} {w}_{ij} & [ Math . 4 ]\end{matrix}$$

is the total input to hidden unit j and pⱼ=σ(xⱼ) is the probability that hⱼ=1 given v.

In some embodiments, instead of trying to impute the missing values, the systems and methods described herein may be configured to behave as though the corresponding label elements do not exist. RBMs or DBMs with different numbers of visible units may be used for different training cases. The different RBMs or DBMs may form a family of different models with shared weights. The hidden biases may be scaled by the number of visible units in an RBM or DBM.

In some embodiments, the methods for handling missing values are used during the training of a generative model where the training data comprises fingerprints and/or labels with missing values.

In various embodiments, the generative models described herein are trained on multimodal data, for example data comprising fingerprint data (F), genetic information (G), and test results (R). Such trained generative models may be used to generate fingerprints, labels, and/or elements thereof. Fingerprint data may be represented in vectors v^{F}, for example v^{F}=(f₁, f₂, f₃, f₄, f₅). Genetic information may be represented in vectors v^{G}, for example v^{G}=(g₁, g₂, g₃, g₄, g₅, g₆). Test results may be represented in vectors v^{R}, for example v^{R}=(r₁, r₂, r₃). In various embodiments, the systems and methods described herein are used in applications where one or more modalities and/or elements thereof are missing. Similarly, the systems and methods described herein may be used in applications in which certain label element values are specified and other label element values are generated such that the generated label elements have a high likelihood of satisfying the conditions set by the specified label element values. Generative models described herein in various embodiments may be used to generate fingerprint and/or label elements, given other fingerprint and/or label elements. For example, a generative model may be used to generate f₁ and f₂, given f₃, f₄, f₅, g₁, g₂, g₃, g₄, g₅, g₆, r₁, r₂, and r₃. A multimodal DBM may be used to generate missing values of a data modality or element thereof, for example by clamping the input values for one or more modalities and/or elements thereof and sampling the hidden modalities. In some embodiments Gibbs sampling is used to generate missing values for one or more data modalities and/or elements thereof, for example to generate f₁ and f₂, given f₃, f₄, f₅, g₁, g₂, g₃, g₄, g₅, g₆, r₁, r₂, and r₃. The input values, such as f₃, f₄, f₅, g₁, g₂, g₃, g₄, g₅, g₆, r₁, r₂, and r₃ may be input into the model and fixed. The hidden units may be initialized randomly. Alternating Gibbs sampling may be used to draw samples from the distribution P(F|G, R), for example by updating each hidden layer given the states of the adjacent layers. The sampled values of f₁ and f₂ from this distribution may define approximate distributions for the true distribution of f₁ and f₂. This approximate distribution may be used to sample values for f₁ and f₂. Sampling from such an approximate distribution may be repeated one or more times after one or more Gibbs steps, such as after about or at least about 2, 3, 4, 5, 6, 7, 8, 9, 10, 15, 20, 25, 30, 40, 50, 60, 70, 80, 90, 100, 200, 300, 400, 500, or more Gibbs steps. In some embodiments, the generative models described herein may be used to sample from an approximate distribution one or more times after less than about 500, 400, 300, 200, 100, 90, 80, 70, 60, 50, 40, 30, 25, 20, 15, 10, 9, 8, 7, 6, 5, 4, 3, or 2 Gibbs steps. Sampling from an approximate distribution may be repeated about or at least about 2, 3, 4, 5, 6, 7, 8, 9, 10, 15, 20, 25, 30, 40, 50 60, 70, 80, 90, 100, 200, 300, 400, 500, or more times. In some embodiments, generative models described herein may be used to sample from such an approximate distribution fewer than about 500, 400, 300, 200, 100, 90, 80, 70, 60, 50, 40, 30, 25, 20, 15, 10, 9, 8, 7, 6, 5, 4, or 3 times.

In some embodiments, convergence generation methods may be used to generate f₁ and f₂, given f₃, f₄, f₅, g₁, g₂, g₃, g₄, g₅, g₆, r₁, r₂, and r₃. (j₁, j₂, f₃, f₄, f₅), (g₁, g₂, g₃, g₄, g₅, g₆), (r₁, r₂, r₃) may be input into the model, where j₁ and j₂ are random values. A joint representation h may be inferred. Based on the joint representation h, values for v^{F̂}, v^{Ĝ}, and v^{R̂} may be generated for F̂, Ĝ, R̂. Values f₁ and f₂ from F̂ may be retained, while all other values of F̂, Ĝ, R̂ are substituted with desired values (f₃, f₄, f₅), (g₁, g₂, g₃, g₄, g₅, g₆), and (r₁, r₂, r₃). The process may be repeated to generate new F̂, Ĝ, R̂, retain new values for f₁ and f₂, and replace all other values of F̂, Ĝ, R̂. In some embodiments, the process is repeated until a selected number of iterations has been run. For example, the process may be repeated about or at least about 2, 3, 4, 5, 6, 7, 8, 9, 10, 15, 20, 25, 30, 40, 50 60, 70, 80, 90, 100, 200, 300, 400, 500, or more times. In some embodiments, the process is repeated fewer than about 500, 400, 300, 200, 100, 90, 80, 70, 60, 50, 40, 30, 25, 20, 15, 10, 9, 8, 7, 6, 5, 4, or 3 times.

The systems and methods described herein may output the values of f₁ and f₂ that appear the most often, or another suitable statistic based on the generated values of f₁ and f₂. The type of the statistic may be chosen according to the distribution from which f₁ and f₂. are sampled.

In some embodiments, the process is repeated until f₁ converges to f₁* and f₂ converges to f₂*. The systems and methods described herein may output the values of to f₁* and f₂* as the result of the generation.

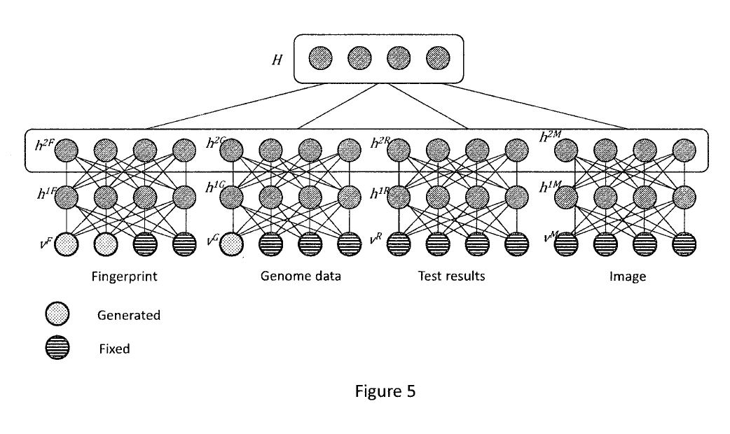

FIG. 5 illustrates an exemplary embodiment of the invention comprising a generative model having two levels configured to generate values for elements of two different data modalities. As an example, a set of chemical compounds may be represented as F=(f₁, f₂, f₃). These compounds may be associated with a set of test result labels R=(r₁, r₂), and with a set of genetic information labels G=(g₁, g₂). A trained generative model may be used to generate values of f₁, f₂, and g₁ given values of f₃, and g₂. More broadly, a generative model trained on a training set of fingerprints and various types of labels may generate values for the elements of multiple data types/modalities.

In some embodiments Gibbs sampling is used to generate missing values for multiple elements belonging to different data modalities and/or elements thereof, for example to generate values of f₁, f₂, and g₁ given values of f₃, g₂, r₁, and r₂. f₁, f₂, and g₁ may be initialized with an initialization method, such as drawing values from a standard normal distribution. The generation process may proceed iteratively as follows. To sample an initial value of f₁, the given values of f₃, g₂, r₁, r₂ and the initialized values of f₁ f₂, and g₁ may be input to the visible layer of a multimodal DBM. From this input, the multimodal DBM may generate a value for f₁. In the next step, this value of f₁, the initialized values of f₂ and g₁, and the given values of f₃, g₂, r₁, and r₂ may be input to the visible layer of the multimodal DBM. From this input, a value of f₂ may be generated. Next, the generated values of f₁ (from the first step) and f₂ (from the second step), and the given values of f₃, g₂, r₁, and r₂ may be input to the visible layer of the multimodal DBM. From this input a value of g₁ may be generated. This process may be repeated iteratively, keeping the values of f₃, g₂, r₁, and r₂ fixed while allowing the values of f₁, f₂, and g₁ to vary with each iteration. After every iteration, the value of the variable that was generated in that iteration may replace the previous value and may be used in the next iteration. Values of f₁, f₂, and g₁ may be repeatedly generated until a convergence is reached for all three values.

<Architecture and Training>

In some embodiments, the generative models of the systems and methods described herein may comprise one or more undirected graphical models. Such an undirected graphical model may comprise binary stochastic visible units and binary stochastic hidden units, for example in an RBM or DBM. An RBM may define the following energy function E: {0,1}^{D}×{0,1}^{F}→R

$$E ( v , h ; θ ) = - {\sum }_{i = 1}^{D} {\sum }_{j = 1}^{F} {W}_{ij} {v}_{i} {h}_{j} - {\sum }_{i = 1}^{D} {b}_{i} {v}_{i} - {\sum }_{j = 1}^{F} {a}_{j} {h}_{j} , \qquad [ Math . 5 ]$$

where θ={a, b, W} are the model parameters: Wᵢⱼ represents the symmetric interaction term between visible unit i and hidden unit j; bᵢ and aⱼ are bias terms. The joint distribution over the visible and hidden units may be defined by

$$P ( v , h ; θ ) = \frac{1}{Z ( θ )} exp ( - E ( v , h ; θ ) ) , \\ Z ( θ ) = {\sum }_{v}^{ } {\sum }_{h} exp ( - E ( v , h ; θ ) ) , \qquad [ Math . 6 ]$$

where Z(θ) is the normalizing constant. Given a set of observations, the derivative of the log-likelihood with respect to the model parameters can be obtained. Without being bound by theory such derivative may relate to the difference between a data-dependent expectation term and model's expectation term.

In some embodiments, such an undirected graphical model may comprise visible real-valued units and binary stochastic hidden units, for example in a Gaussian-Bernoulli RBM. The energy of the state of the Gaussian-Bernoulli RBM may be defined as

$$E ( v , h ; θ ) = {\sum }_{i = 1}^{D} \frac{{( {v}_{i} - {b}_{i} )}^{2}}{2 {σ}_{i}^{2}} - {\sum }_{i = 1}^{D} {\sum }_{j = 1}^{F} \frac{{v}_{i}}{{σ}_{i}} {W}_{ij} {h}_{j} - {\sum }_{j = 1}^{F} {a}_{j} {h}_{j} , \qquad [ Math . 7 ]$$

where θ={a, b, W, σ} are the model parameters. The density that the model assigns to a visible vector v may be given by

$$P ( v ; θ ) = \frac{1}{Z ( θ )} {\sum }_{h} exp ( - E ( v , h ; θ ) ) , \\ Z ( θ ) = {\int }_{v} {\sum }_{h} exp ( - E ( v , h ; θ ) ) dv . \qquad [ Math . 8 ]$$

In some embodiments, an undirected graphical model may comprise visible and hidden real-valued units. Both sets of units may comprise Gaussian transfers. The energy function may be given by

$$E ( v , h ) = {\sum }_{i ∈ vis} \frac{{( {v}_{i} - {a}_{i} )}^{2}}{2 {σ}_{i}^{2}} + {\sum }_{j ∈ hid} \frac{{( {h}_{j} - {b}_{j} )}^{2}}{2 {σ}_{j}^{2}} - {\sum }_{ij} \frac{{v}_{i}}{{σ}_{i}} \frac{{h}_{j}}{{σ}_{j}} {w}_{ij} \qquad [ Math . 9 ]$$

where θ={a, b, W, σ} are the model parameters.

In some embodiments, such an undirected graphical model may comprise binomial or rectified linear visible and/or hidden units.

The generative models of the systems and methods described herein may also comprise Replicated Softmax Models (RSMs). In various embodiments, RSMs are used for modeling sparse count data, such as word count vectors in a document. An RSM may be configured to accept into its visible units, the number of times a word k occurs in a document with the vocabulary size K. The hidden units of the RSM may be binary stochastic. The hidden units may represent hidden topic features. Without being bound by theory, RSMs may be viewed as RBM models having a single visible multinomial unit with support {1, . . . , K} which is sampled M times, wherein M is the number of words in the document. An M×K observed binary matrix V may be used with vᵢₖ=1 if and only if the multinomial visible unit i takes on k^{th} value (meaning the i^{th} word in the document is the k^{th} dictionary word). The energy of the state {V, h} can be defined as

$$E ( V , h ) = - {\sum }_{i = 1}^{M} {\sum }_{j = 1}^{F} {\sum }_{k = 1}^{K} {W}_{ijk} {v}_{ik} {h}_{j} - {\sum }_{i = 1}^{M} {\sum }_{k = 1}^{K} {b}_{ik} {v}_{ik} - {\sum }_{j = 1}^{F} {a}_{j} {h}_{j} , \qquad [ Math . 10 ]$$

where {a, b, W} are the model parameters: Wᵢⱼₖ represents the symmetric interaction term between visible unit i and hidden feature j; bᵢₖ is the bias of unit I that takes on value k; and and aⱼ is the bias of hidden feature j. The probability that the model assigns to a visible binary matrix V is

$$P ( V , h ; θ ) = \frac{1}{Z ( θ )} exp ( - E ( v , h ; θ ) ) , \\ Z ( θ ) = {\sum }_{V}^{ } {\sum }_{h} exp ( - E ( V , h ; θ ) ) . \qquad [ Math . 11 ]$$

A separate RBM with as many softmax units as there are words in a document may be created for each document.

In various embodiments, maximum likelihood learning is used to train each of these architectures. In some embodiments, learning is performed by following an approximation to the gradient of a different objective function.

In some embodiments, the generative models of the systems and methods described herein may comprise one or more networks of symmetrically coupled stochastic binary units, such as DBMs. A DBM may comprise a set of visible units v∈{0, 1}^{D}, and a sequence of layers of hidden units h⁽¹⁾∈{0, 1}^{F1}, h⁽²⁾∈{0, 1}^{F2}, . . . , h^{(L)}∈{0, 1}^{FL}. A DBM may comprise connections only between hidden units in adjacent layers, as well as between visible and hidden units in the first hidden layer. Consider a DBM with three hidden layers (i.e., L=3). The energy of the joint configuration {v, h} is defined as

$$E ( v , h ; θ ) = - {\sum }_{i = 1}^{D} {\sum }_{j = 1}^{{F}_{1}} {W}_{ij}^{( 1 )} {v}_{i} {h}_{j}^{( 1 )} - {\sum }_{j = 1}^{{F}_{1}} {\sum }_{l = 1}^{{F}_{2}} {W}_{ji}^{( 2 )} {h}_{j}^{( 1 )} {h}_{l}^{( 2 )} - {\sum }_{l = 1}^{{F}_{2}} {\sum }_{p = 1}^{{F}_{3}} {W}_{ip}^{( 3 )} {h}_{i}^{( 2 )} {h}_{p}^{( 3 )} - {\sum }_{i = 1}^{D} {b}_{i} {v}_{i} - {\sum }_{j = 1}^{{F}_{1}} {b}_{j}^{( 1 )} {h}_{j}^{( 1 )} - {\sum }_{l = 1}^{{F}_{2}} {b}_{l}^{( 2 )} {h}_{l}^{( 2 )} - {\sum }_{p = 1}^{{F}_{3}} {b}_{p}^{( 3 )} {h}_{p}^{( 3 )} , \qquad [ Math . 12 ]$$

where h={h⁽¹⁾; h⁽²⁾; h⁽³⁾} is the set of hidden units and θ={W⁽¹⁾; W⁽²⁾; W⁽³⁾; b⁽¹⁾; b⁽²⁾; b⁽³⁾} the set of model parameters, representing visible-to-hidden and hidden-to hidden symmetric interaction terms, as well as bias terms. The probability that the model assigns to a visible vector v is given by the Boltzmann distribution

$$P ( v ; θ ) = \frac{1}{Z ( θ )} {\sum }_{h} exp ( - E ( v , {h}^{( 1 )} , {h}^{( 2 )} , {h}^{( 3 )} ; θ ) ) . \qquad [ Math . 13 ]$$

Deep Boltzmann Machines (DBMs) may be trained using a layer-by-layer pre-training procedure. DBMs may be trained on unlabeled data: DBMs may be fine-tuned for a specific task using labeled data. DBMs may be used to incorporate uncertainty about missing or noisy inputs by utilizing an approximate inference procedure that incorporates a top-down feedback in addition to the usual bottom-up pass. Parameters of all layers of DBMs may be optimized jointly, for example by following the approximate gradient of a variational lower-bound on the likelihood objective.

The generative models of the systems and methods described herein may comprise recurrent neural networks (RNNs). In various embodiments, RNNs are used for modeling variable-length inputs and/or outputs. An RNN may be trained to predict the next output in a sequence, given all previous outputs. A trained RNN may be used to model joint probability distribution over sequences. An RNN may comprise a transition function that determines the evolution of an internal hidden state and a mapping from such state to the output. In some embodiments, generative models described herein comprise an RNN having a deterministic internal transition structure. In various embodiments, generative models described herein comprise an RNN having latent random variables. Such RNNs may be used to model variability in data.

In some embodiments, the generative models of the systems and methods described herein comprise a variational recurrent neural network (VRNN). A VRNN may be used to model the dependencies between latent random variables across subsequent timesteps. A VRNN may be used to generate a representation of a single-modality time series that can then be input to the second level of the network to be used in the joint data representation.

A VRNN may comprise a variational auto-encoder (VAE) at one, more, or all timesteps. The VAEs may be conditioned on the hidden state variable hₜ₋₁ of an RNN. In various embodiments, such VAEs may be configured to take into account the temporal structure of sequential data.

In some embodiments, the prior on the latent random variable of a VRNN follows the distribution:

zₜ˜N(μ_{0,t},diag(σ_{0,t}²)), where [μ_{0,t},σ_{0,t}]=φ_{T}^{prior}(hₜ₋₁), [Math. 14]

where μ_{0,t} and σ_{0,t} denote the parameters of the conditional prior distribution. The generating distribution may be conditioned on zₜ and hₜ₋₁ such that:

xₜ|zₜ˜N(μ_{x,t},diag(σ_{x,t}²)), where [μ_{x,t},σ_{x,t}]=φₜ^{dec}(φ_{T}^{z}(zₜ),hₜ₋₁), [Math. 15]

where μ_{x,t} and σ_{x,t} denote the parameters of the generating distribution. φ_{T}^{x} and φ_{T}^{z} may extract features from xₜ and zₜ, respectively. φ_{T}^{prior}, φ_{T}^{dec}, φ_{T}^{x}, and/or φ_{T}^{z} may be a highly flexible function, for example a neural network. The RNN may update its hidden state using a recurrence equation such as:

hₜ=f_{θ}(φ_{T}^{x}(xₜ),φ_{T}^{z}(zₜ),hₜ₋₁), [Math. 16]

where f is a transition function. The RNN may update its hidden state according to the transition function. The distributions p(zₜ|x_{<t}, z_{<t}) and p(xₜ|z_{≤t}, x_{<t}) may be defined with the equations above. The parametrization of the generative model may lead to

$$p ( {x}_{\leq T} , {z}_{\leq T} ) = {\prod }_{t = 1}^{T} p ( {x}_{t} \vert {z}_{\leq t} , {x}_{< t} ) p ( {z}_{t} \vert {x}_{< t} , {z}_{< t} ) . \qquad [ Math . 17 ]$$

For inference, a VAE may use a variational approximation q(z|x) of the posterior that enables the use of a lower bound:

log p(x)≥−KL(q(z|x)∥p(z))+ [symbol] _{q(z|x)}[log p(x|z)], [Math. 18]

where KL(Q∥P) is Kullback-Leibler divergence between two distributions Q and P. In a VRNN, the approximate posterior q(z|x) may be parameterized as a highly nonlinear function such as a neural network that may output a set of latent variables each of which may be probabilistically described, for example by a Gaussian distribution with mean μ and variance σ².

Without being bound by theory, the encoding of the approximate posterior and the decoding for generation may be tied through the RNN hidden state hₜ₋₁. This conditioning on hₜ₋₁ may result in the factorization:

$$q ( {z}_{\leq T} \vert {x}_{\leq T} ) = {\prod }_{t = 1}^{T} q ( {z}_{t} \vert {x}_{< t} , {z}_{< t} ) . \qquad [ Math . 19 ]$$

The objective function may comprise a timestep-wise variational lower bound:

$${E}_{q ( {z}_{\leq T} \vert {x}_{\leq T} )} [ {\sum }_{t = 1}^{T} ( - KL ( q ( {z}_{t} \vert {x}_{\leq t} , {z}_{< t} ) \vert \vert p ( {z}_{t} \vert {x}_{< t} , {z}_{< t} ) ) + log p ( {x}_{t} \vert {z}_{\leq t} , {x}_{< t} ) ) ] . \qquad [ Math . 20 ]$$

Generative and inference models may be learned jointly, for example by maximizing the variational lower bound with respect to its parameters.

In some embodiments, the generative models of the systems and methods described herein may comprise one or more multimodal DBMs. The various modalities may comprise genetic information, text results, image, text, fingerprint or any other suitable modality described herein or otherwise known in the art.

In a multimodal DBM, two or more models may be combined by an additional layer, such as a layer in a second level on top of the level comprising the DBMs. The joint distribution for the resulting graphical model may comprise a product of probabilities. For example, the joint distribution for a multimodal DBM comprising a DBM having a genetic information modality and a DBM having a test results modality, each DBM having two hidden layers that are joined at an additional third hidden layer h³, may be written as

$$P ( {v}^{G} , {v}^{R} ; θ ) = {\sum }_{{h}^{2 G} , {h}^{2 R} , {h}^{3}} P ( {h}^{2 G} , {h}^{2 R} , {h}^{3} ) ( {\sum }_{{h}^{1 G}} P ( {v}^{G} , {h}^{1 G} \vert {h}^{2 G} ) ( {\sum }_{{h}^{1 R}} P ( {v}^{R} , {h}^{1 R} \vert {h}^{2 R} ) \qquad [ Math . 21 ]$$

Similarly, a multimodal DBM may be configured to model four different modalities. For example, a multimodal DBM may be configured to have a DBM for fingerprints, a DBM for a genetic information, a DBM for test results, and a DBM for image modalities. The joint distribution for a multimodal DBM comprising these four DBMs, each DBM having two hidden layers that are joined at an additional third hidden layer h³, may be written as

$$P ( {v}^{F} , {v}^{G} , {v}^{R} , {v}^{M} ; θ ) = {\sum }_{{h}^{2 F} , {h}^{2 G} , {h}^{2 R} , {h}^{2 M} , {h}^{3}} P ( {h}^{2 F} , {h}^{2 G} , {h}^{2 R} , {h}^{2 M} , {h}^{3} ) ( {\sum }_{{h}^{1 F}} P ( {v}^{F} , {h}^{1 F} \vert {h}^{2 F} ) ( {\sum }_{{h}^{1 G}} P ( {v}^{G} , {h}^{1 G} \vert {h}^{2 G} ) ( {\sum }_{{h}^{1 R}} P ( {v}^{R} , {h}^{1 R} \vert {h}^{2 R} ) ( {\sum }_{{h}^{1 M}} P ( {v}^{M} , {h}^{1 M} \vert {h}^{2 M} ) \qquad [ Math . 22 ]$$

The joint distributions may be generalized to multimodal DBMs, having i modality specific DBMs, each having jᵢ hidden layers, and k additional hidden layers joining the modality specific DBMs. Such multimodal DBMs may utilize any suitable transfer functions described herein or otherwise known in the art.

The methods and systems described herein may use deterministic or stochastic generation methods. For example, Gibbs sampling may be implemented as a stochastic method. In implementation, various steps may be taken to minimize the variation in results. The convergence methods described in further detail elsewhere herein may be implemented as a semi-deterministic method. Convergence methods may be executed for a number of iterations, such as to produce results having consistency above a threshold level.

The transfer functions in the individual layers of each DBM may be selected according to the type of model and the data modality for which the DBM is configured. In some embodiments, a Gaussian distribution is used to model real valued units. In some embodiments, a rectified-linear-unit may be used for hidden layers accepting continuous input. For text, DBMs may use Replicated Softmax to model a distribution over word count. The distribution for the transforms may be chosen in a way that makes gradients of probability distributions with respect to weights/parameters of the model easier to compute.

In various embodiments, the generative models or modules thereof are trained using a suitable training method described herein or otherwise known in the art. The training method may comprise generative learning, where reconstruction of the original input may be used to make estimates about the probability distribution of the original input.

During the training of generative models described herein, each node layer in a deep network may learn features by repeatedly trying to reconstruct the input from which it draws its samples. The training may attempt to minimize the difference between the network's reconstructions and the probability distribution of the input data itself. The difference between the reconstruction and the input values may be backpropagated, often iteratively, against the generative model's weights. The iterative learning process may be continued until a minimum is reached in the difference between the reconstruction and the input values. An RBM or DBM may be used to make predictions about node activations or the probability of output given a weighted input. On a back pass, the RBM or DBM may be used to estimate the probability of inputs given weighted activations where the weights are the same as those used on the forward pass. The two probability estimates may be used to estimate the joint probability distribution of inputs and hidden unit activations.

In various embodiments, the multimodal DBMs or sub-modules thereof described herein are trained using approximate learning methods, for example by using a variational approach. Mean-field inference may be used to estimate data-dependent expectations. Markov Chain Monte Carlo (MCMC) based stochastic approximation procedures may be used to approximate a model's expected statistics. Without being bound by theory, to minimize the distance between an estimated probability distribution and the prior distribution of the ground truth or the distance between an approximate distribution for the hidden units and the posterior, the training method may optimize, e.g. minimize, the Kullback Leibler Divergence (KL-Divergence), often in an iterative process. A variational lower bound for the log likelihood of the model parameters may be maximized by minimizing the KL-Divergence. KL-Divergence between to distributions P1(x) and P2(x) may be denoted by D (P1(x)∥P2(x)) and given by

$$D ( {P}_{1} ( x ) ‖ {P}_{2} ( x ) ) = {\sum }_{x} {P}_{1} ( x ) ln \frac{{P}_{1} ( x )}{{P}_{2} ( x )} . \qquad [ Math . 23 ]$$

KL-Divergence may be minimized by reducing the difference between the prior distribution and the reconstruction distribution or the difference between the posterior distribution and the modeled approximation thereof, such as by using a variational Bayes EM algorithm. The multimodal DBMs or sub-modules thereof may be cycled through layers, updating the mean-field parameters within each individual layer.

In some embodiments, the variational lower bound is maximized for each training example with respect to an approximating distribution's variational parameters μ for fixed parameters θ of the true posterior distribution. The resulting mean-field fixed-point equations may be solved, for example by cycling through layers, updating the mean-field parameters within single layers.

Given variational parameter μ, the model parameters θ of the true posterior may be updated to maximize the variational bound. In some embodiments, training comprises Markov chain Monte-Carlo (MCMC) based stochastic approximation. In some embodiments, Gibbs sampling may be used, for example to sample a new state, given the previous state of the model. A new parameter θ may then be obtained for the new state, for example by making a gradient step. Contrastive divergence (CD), such as persistent CD or CD-k, e.g. CD-1 methods may be applied during training. During a training method comprising contrastive divergence, a Markov chain may be initialized with a training example. In some cases, CD methods do not wait for the Markov chain to converge. Samples may be obtained only after k-steps of Gibbs sampling (CD-k), where k may be 1, 2, 3, 4, 5, 6, 7, 8, 9, or greater. The training method may use a persistent CD relying on a single Markov chain having a persistent state—that is the Markov chain is not restarted for each observed example. An average over the set of persistent Markov chains may be used and/or output by the generative models described herein. Additional suitable methods for constructing, training and generating from multimodal DBMs may be found in Srivastava and Salakhutdinov (Multimodal Learning with Deep Boltzmann Machones; J of Machine Learning Research 15 (2014) 2949-80) which is herein incorporated by reference in its entirety.

In various embodiments, a VRNN module is trained separately from the rest of the model. Training data may comprise a set of time series of the same type, e.g., a set of measurements of tumor size over time taken from a variety of patients.

In some embodiments, a greedy, layerwise and unsupervised pre-training is performed. The training methods may comprise training multiple layers of a generative model by training a deep structure layer by layer. Once a first RBM within a deep module is trained, the data may be passed one layer down the structure. The first hidden layer may take on the role of a visible layer for the second hidden layer where the first hidden layer activations are used as the input for the second hidden layer and are multiplied by the weights at the nodes of the second hidden layer. With each new hidden layer, the weights may be adjusted until that layer is able to approximate the input from the previous layer.

In some embodiments, multimodal generative models, such as multimodal DBMs, are used to generate a joint representation of multimodal data, by combining multiple data modalities. To infer the joint representation conditioned on input values for one or more modalities and/or elements thereof, the input modalities may be clamped. Gibbs sampling may be performed to sample from the conditional distribution for a hidden layer, such as a hidden layer combining representations from multiple modalities, given the input values. In some embodiments, variational inference is used to approximate a posterior approximate conditional distribution for a hidden layer, such as a hidden layer combining representations from multiple modalities, given the input values. The variational parameters it of the approximate posterior may be used to constitute the joint representation of the inputs. The joint representations may be used for information retrieval for multimodal or unimodal queries.

In various embodiments, the training methods comprise features to adjust model complexity. The training methods may employ regularization methods that help fight overfitting of the generative models described herein. A regularization constraint may be imposed by a variety of ways. In some embodiments, regularization is achieved by assigning a penalty for large weights. Overfitting may be curtailed by weight-decay, weight-sharing, early stopping, model averaging, Bayesian fitting of neural nets, dropout, and/or generative pre-training.

Training algorithms described herein may be adapted to the particular configuration of the generative model that is employed within the computer systems and methods described in further detail elsewhere herein. A variety of suitable training algorithms described herein or otherwise known in the art can be selected for the training of the generative models of the invention described elsewhere herein in further detail. The appropriate algorithm may depend on the architecture of the generative model and/or on the task that the generative model is desired perform.

In some embodiments, a generative model is trained to optimize the variational lower bound using variational inference alone or in combination with stochastic gradient ascent. In some embodiments, semi-supervised learning methods are used, for example when the training data has missing values.

In various embodiments, the systems and methods described herein may comprise a predictor module, a ranking module, a comparison module, or combinations thereof.

Additional system modules can be introduced to the systems and methods described herein. For example, a comparison module may be used to compare two fingerprints, two sets of test results, genetic profiles of healthy and unhealthy samples, cells, tissues, or organisms, or any other pair of information described herein suitable for comparison. A ranking module may be used to rank the members of a set of fingerprints by a druglikeness score, members of a set of genetic profiles by a likelihood of being a successful profile for a chemical compound's desired effect, or any set of generated values described herein suitable for ranking. A classifier may be used to classify a compound fingerprint by assigning a druglikeness score. An ordering module may be used to order a set of scored fingerprints. A predictor may be used to predict missing values for one or more data modalities. A masking module may be used to handle data sets having sparse or missing values. Such modules are described in further detail elsewhere herein and in U.S. Pat. App. No. 62/262,337, which is herein incorporated by reference in its entirety.

<Predictor>

The systems and methods of the invention described herein can utilize representations of chemical compounds, such as fingerprinting data. Label information associated with a part of the data set may be missing. For example, for some compounds assay data may be available, which can be used directly in the training of the generative model. For one or more other compounds, label information may not be available. In certain embodiments, the systems and methods of the invention comprise a predictor module for partially or completely assigning label values to a compound and associating it with its fingerprint data. In an exemplary embodiment of semi-supervised learning, the training data set used for training the generative model comprises both compounds that have experimentally identified label information and compounds that have labels predicted by the predictor module.

The predictor may comprise a machine learning classification model. In some embodiments, the predictor is a deep graphical model with two, three, four, five, six, seven, eight, nine, ten, eleven, twelve, thirteen, fourteen, fifteen, sixteen, or more layers. In some embodiments, the predictor is a random forest classifier. In some embodiments, the predictor is trained with a training data set comprising chemical compound representations and their associated labels. In some embodiments, the predictor is previously trained on a set of chemical compound representations and their associated labels that are different from the training data set used to train the generative model.

Fingerprints that were initially unlabeled for one or more label elements may be associated with a label element value for one or more label elements by the predictor. In one embodiment, a subset of the training data set may comprise fingerprints that do not have associated labels. For example, compounds that may be difficult to prepare and/or difficult to test may be completely or partially unlabeled. In this case, a variety of semi-supervised learning methods may be used. In one embodiment, the set of labeled fingerprints is used to train the predictor module. In one embodiment, the predictor implements a classification algorithm, which is trained with supervised learning. After the predictor has been trained sufficiently, unlabeled fingerprints may be input to the predictor in order to generate a predicted label. The fingerprint and its predicted label may then be added to the training data set, which may be used to train the generative model.

In some embodiments, one or more methods for handling missing values described in further detail under Generation and elsewhere herein form the basis for a predictor module.

Predictor-labeled chemical compounds may be used to train the first generative model or a second generative model. The predictor may be used to assign label element values to a fingerprint that lacks label information. By the use of the predictor, the generative models described in further detail elsewhere herein may be trained on a training data set partially comprising predicted labels. Generative models described in further detail elsewhere herein, once trained, may be used to create generated representations of chemical compounds, such as fingerprints. Generated representations of chemical compounds may be produced based on a variety of conditions imposed by desired labels.

<Methods>

In some embodiments, generative models described herein are used to generate representations of new chemical compounds that were not presented to the model during the training phase. In some embodiments, the generative model is used to generate chemical compound representations that were not included in the training data set. In this way, novel chemical compounds that may not be contained in a chemical compound database, or may not have even been previously conceived, may be generated. The model having been trained on a training set comprising real chemical compounds may have certain advantageous characteristics. Without being bound by theory, training with real chemical compound examples or with drugs, which have a higher probability to work as functional chemicals, may teach the model to generate compounds or compound representations that may possess similar characteristics with a higher probability than, for example, hand-drawn or computationally generated compounds using residue variation.

In some embodiments, generative models described herein are used to generate label values associated with an input fingerprint. The generated label values may have not been presented to the model during the training phase. In some embodiments, the generative model is used to generate label values that were not included in the training data set. In this way, novel label values, such as novel combinations of genetic characteristics that may not have been in the training data, may be generated.

The compounds associated with the generated representations may be added to a chemical compound database, used in computational screening methods, and/or synthesized and tested in assays. The generated label values may be stored in databases that link drug information to patient populations. The database may be mined an d used for personalized drug development, personalized drug prescription, or for clinical trials targeting precise patient populations,

The generative models described herein may be used to generate compounds that are intended to be similar to a specified seed compound. In various embodiments, a seed compound may be used to specify, or fix, values for a certain number of elements in the chemical compound representation. The generative models described herein may generate values for the unspecified elements, such that the complete compound representation has a high likelihood of meeting the conditions set by the specified values in other data modalities. In various embodiments, the systems and methods described herein are utilized to generate representations of chemical compounds, e.g., fingerprints, using a seed compound as a starting point. Compounds similar to a seed may be generated by inputting a seed compound and its associated labels to the generative model. Using the representation of the seed compound as the starting point, the generative model may sample from the joint probability distribution to generate one or more values for a chemical compound fingerprint. The generated values may comprise a fingerprint of a compound that is expected to have some similarity to the seed compound and/or to have a high likelihood of meeting the requirements defined by the input labels.

The seed compound may be a known compound for which certain experimental results are known and it may be expected that the structural properties of the generated compound will bear some similarity to those of the seed compound. For example, a seed compound may be an existing drug that is being repurposed or tested for off-label use and it may be desirable that a generated candidate compound retain some of the beneficial activities of the seed compound, such as low toxicity and high solubility, but exhibit different activities on other assays, such as binding with a different target, as required by the desired label. A seed compound may also be a compound that has been physically tested to possess a subset of desired label outcomes, but for which an improvement in certain other label outcomes, such as decreased toxicity, improved solubility, and/or improved ease of synthesis, is desired. Comparative generation may therefore be used to generate compounds intended to possess structural similarity to the seed compound but to exhibit different label outcomes, such as a desired activity in a particular assay.

In some embodiments, the generative model is used to generate genetic information values that are intended to be similar to a specified seed genetic information input. Compounds similar to a seed may be generated by inputting a seed compound and its associated labels to the generative model. Using the representation of the seed compound as the starting point, the generative model may sample from the joint probability distribution to generate one or more values for a genetic information label. The generated values may comprise genetic information that is expected to have some similarity to the seed values and/or to have a high likelihood of meeting the requirements defined by the input labels of other types.

In some embodiments, the training phase comprises using fingerprint data and associated label values to train the generative model and a predictor concurrently.

An important benefit of the invention is the ability to discover drugs that may have fewer side effects. The generative models described herein may be trained by including in the training data set compound activities for particular assays for which certain results are known to be responsible for causing side effects and/or toxic reactions in samples, cells, tissues, or organisms, such as humans or animals, alone or in combination with genetic information related to such subjects. Accordingly, a generative model may be taught the relationships between chemical compound representations and beneficial and unwanted effects. In various embodiments, such relationships are taught in relation to the genetic information of the samples, cells, tissues, or organisms. In the generation phase, a desired test results label input to a generative model may specify desired compound activity on assays associated with beneficial effects and/or unwanted side effects. The generative model can then generate representations of chemical compounds that simultaneously satisfy both beneficial effect and toxicity/side effect requirements. In some embodiments, the generative model generates representations of chemical compounds that simultaneously satisfy further inputs, such as beneficial effect and toxicity/side effect requirements given a genetic information background.

By simultaneously satisfying a plurality of desired outcomes provided as input, the methods and systems described herein enable more efficient exploration in the earlier stages of the drug discovery process, thereby possibly reducing the number of clinical trials that fail due to unacceptable side effects or efficacy levels of a tested drug. This may lead to reductions in both the duration and the cost of the drug discovery process.

In some embodiments, the methods and systems described herein are used to find new targets for chemical compounds that already exist. For example, the generative networks described herein may produce a generated representation for a chemical compound based on a desired test result label, wherein the chemical compound is known to have another effect. Accordingly, a generative model trained with multiple test result label elements, may generate a representation for a chemical compound that is known to have a first effect, in response to the use of the generative phase by inputting a desired test result label for a different effect, effectively identifying a second effect. In some embodiments, such second effects may be identified for a particular genetic information label. In some embodiments, the generative model is used to also generate a genetic information label, thereby finding a second effect for a chemical compound for a particular subpopulation having a genetic profile that aligns with the generated genetic information. Thus, the generative model may be used to identify a second label for a pre-existing chemical compound and in some cases, a target patient population for such second effect. In some embodiments, the generative model is previously trained with a training data set comprising the first effect for the chemical compound. In some embodiments, the generative model is previously trained with a training data set comprising genetic information for the first effect of the chemical compound. Chemical compounds so determined are particularly valuable, as repurposing a clinically tested compound may have lower risk during clinical studies and further, may be proven for efficacy and safety efficiently and inexpensively.

In some embodiments, the generative models herein may be trained to learn the value for a label element type in a non-binary manner. The generative models herein may be trained to recognize higher or lower levels of a chemical compound's effect with respect to a particular label element. Accordingly, the generative models may be trained to learn the level of effectiveness and/or the level of toxicity or side effects for a given chemical compound.

The methods and systems described herein are particularly powerful in generating representations of chemical compounds, including chemical compounds that were not presented to the model and/or chemical compounds that did not previously exist. Thus, the systems and methods described herein may be used to expand chemical compound libraries. Further, the various embodiments of the invention also facilitate conventional drug screening processes by allowing the output of the generative models to be used as an input dataset for a virtual or experimental screening process.

The methods and systems described herein may also draw inferences for the interaction of genetic information elements with each other and/or with the test results of a chemical compound. Such interactions may be previously unknown. Thus, the systems and methods described herein may be used to expand biomarker libraries, identify new drug and/or gene therapy targets.

In various embodiments, the generated representations relate to chemical compounds having similarity to the chemical compounds in the training data set. The similarity may comprise various aspects. For example, a generated chemical compound may have a high degree of similarity to a chemical compound in the training data set, but it may have a much higher likelihood of being chemically synthesizable and/or chemically stable than the chemical compound in the training data set to which it is similar. Further, a generated compound may be similar to a chemical compound in the training data set, but it may have a much higher likelihood of possessing desired effects and/or lacking undesired effects than existing compound in the training data set.

In various embodiments, the methods and systems described herein generate chemical compounds or representations thereof taking into account their ease of synthesis, solubility, and other practical considerations. In some embodiments, generative models are trained using label elements that may include solubility or synthesis mechanisms. In some embodiments, a generative model is trained using training data that includes synthesis information or solubility level. Desired labels related to these factors may be used in the generation phase to increase the likelihood that the generated chemical compound representations relate to compounds that behave according to the desired solubility or synthesis requirements.

In various drug discovery applications, multiple candidate fingerprints may be generated. A set of generated fingerprints can then be used to synthesize actual compounds that can be used in high throughput screening. Prior to compound synthesis and HTS, generated fingerprints may be evaluated for having the desired assay results and/or structural properties. Generated fingerprints may be evaluated based on their predicted results and their similarity to a seed compound. If the generated fingerprints have the desired properties, they may be ranked based on their druglikeness.

In various embodiments, the systems and methods described herein comprise one or more modules that are configured to compare and/or cluster two or more sets of data, for example data comprising generated values. Systems and methods for comparison and clustering are further described in U.S. Pat. App. No. 62/262,337, which is herein incorporated by reference in its entirety. Such systems and methods may, for example, identify compound properties that may affect results on a specific assay or components of genetic information that may correlate with disease, immunity, and/or responsiveness to a treatment, such as treatment with a drug.

In some embodiments, the methods and systems described herein may be used to identify gene editing strategies. Such gene editing strategies may be based on identification of new biomarkers and/or disease associated genes and/or mutations therein. In some embodiments, the gene editing strategies may further comprise the use of a chemical compound in combination. The chemical compound may be a previously known compound, including but not limited to an approved drug. In some embodiments, the chemical compound is generated by the systems and methods described herein.

In various embodiments, the generative models described herein, for example a multimodal DBM, are configured to accept as input more than one drug. For example, a multimodal DBM may be configured with two single-modality DBMs, each of which is configured to accept a representation of a chemical compound, in the first level of the network. Using such network architectures, the methods and systems described herein may be used to generate combinations of drugs that together satisfy the conditions set by the specified values of the other input data modalities.

<Fingerprinting>

Chemical compounds may be preprocessed to create representations, for example fingerprints that can be used in the context of the generative models described herein. In some cases, the chemical formula of a compound may be restored from its representation without degeneracy. In other cases, a representation may map onto more than a single chemical formula. In yet other cases, no identifiable chemical formula that can be deduced from the representation may exist. A nearest neighbor search may be conducted in the representation space. Identified neighbors may lead to chemical formulas that may approximate the representation generated by the generative model.

In various embodiments, the methods and systems described herein utilize fingerprints to represent chemical compounds in inputs and/or outputs of generative models.

Molecular descriptors of various types may be used in combination to represent a chemical compound as a fingerprint. In some embodiments, chemical compound representations comprising molecular descriptors are used as input to various machine learning models. In some embodiments, the representations of the chemical compounds comprise at least or at least about 50, 100, 150, 250, 500, 1000, 2000, 3000, 4000, 5000, or more molecular descriptors. In some embodiments, the representations of the chemical compounds comprise fewer than 10000, 7500, 5000, 4000, 3000, 2000, 1000, 500, 250, 150, 200, or 50 molecular descriptors.

The molecular descriptors may be normalized over all the compounds in the union of all the assays and/or threshold.

Chemical compound fingerprints typically refer to a string of values of molecular descriptors that contain the information of a compound's chemical structure (e.g. in the form of a connection table). Fingerprints can thus be a shorthand representation that identifies the presence or absence of some structural feature or physical property in the original chemistry of a compound.

In various embodiments, fingerprinting comprises hash-based or dictionary-based fingerprints. Dictionary-based fingerprints rely on a dictionary. A dictionary typically refers to a set of structural fragments that are used to determine whether each bit in the fingerprint string is ‘on’ or ‘off’. Each bit of the fingerprint may represent one or more fragments that must be present in the main structure for that bit to be set in the fingerprint.

Some fingerprinting applications may use the “hash-coding” approach. Accordingly, the fragments present in a molecule may be “hash-coded” to fingerprint bit positions. Hash-based fingerprinting may allow all of the fragments present in the molecule to be encoded in the fingerprint.

Generating representations of chemical compounds as fingerprints may be achieved by using publicly available software suites from a variety of vendors. (See e.g. www.talete.mi.it/products/dragon_molecular_descriptor_list.pdf, www.talete.mi.it/products/dproperties_molecular_descriptors.htm, www.moleculardescriptors.eu/softwares/softwares.htm, www.dalkescientific.com/writings/diary/archive/2008/06/26/fingerprint_background.html, or vega.marionegri.it/wordpress/resources/chemical-descriptors).

<Computer Systems>

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The descriptions presented herein are not inherently related to any particular computer or other apparatus. In addition to general-purpose systems, more specialized apparatus may be constructed to practice the various embodiments of the invention. In addition, the present invention is not described with reference to any particular programming language. It will be appreciated that a variety of programming languages may be used to implement the teachings of the invention as described herein. A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

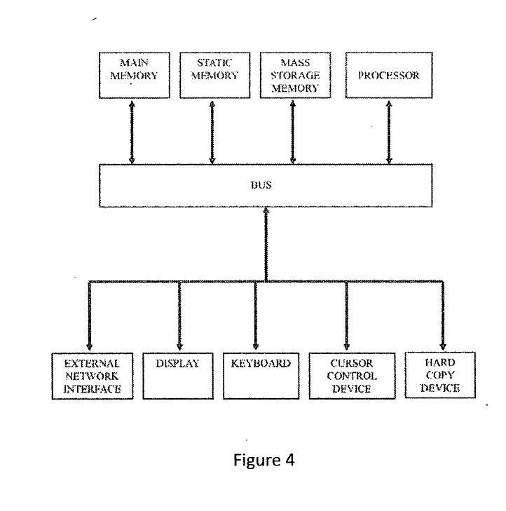

FIG. 4 is a block diagram of an exemplary computer system that may perform one or more of the operations described herein. Referring to FIG. 4, the computer system may comprise an exemplary client or server computer system. The computer system may comprise a communication mechanism or bus for communicating information, and a processor coupled with a bus for processing information. The processor may include a microprocessor, but is not limited to a microprocessor, such as, for example, Pentium, PowerPC, Alpha, etc. The system further comprises a random access memory (RAM), or other dynamic storage device (referred to as main memory) coupled to the bus for storing information and instructions to be executed by the processor. Main memory also may be used for storing temporary variables or other intermediate information during execution of instructions by the processor. In various embodiments, the methods and systems described herein utilize one or more graphical processing units (GPUs) as a processor. GPUs may be used in parallel. In various embodiments, the methods and systems of the invention utilize distributed computing architectures having a plurality of processors, such as a plurality of GPUs.

The computer system may also comprise a read only memory (ROM) and/or other static storage device coupled to the bus for storing static information and instructions for the processor, and a data storage device, such as a magnetic disk or optical disk and its corresponding disk drive. The data storage device is coupled to the bus for storing information and instructions. In some embodiments, the data storage devices may be located in a remote location, e.g. in a cloud server. The computer system may further be coupled to a display device, such as a cathode ray tube (CRT) or liquid crystal display (CD), coupled to the bus for displaying information to a computer user. An alphanumeric input device, including alphanumeric and other keys, may also be coupled to the bus for communicating information and command selections to the processor. An additional user input device is a cursor controller, such as a mouse, trackball, track pad, stylus, or cursor direction keys, coupled to the bus for communicating direction information and command selections to the processor, and for controlling cursor movement on the display. Another device that may be coupled to the bus is a hard copy device, which may be used for printing instructions, data, or other information on a medium such as paper, film, or similar types of media. Furthermore, a sound recording and playback device, such as a speaker and/or microphone may optionally be coupled to the bus for audio interfacing with the computer system. Another device that may be coupled to the bus is a wired/wireless communication capability for communication to a phone or handheld palm device.

Note that any or all of the components of the system and associated hardware may be used in the present invention. However, it can be appreciated that other configurations of the computer system may include some or all of the devices.

1. A computer system comprising a multimodal generative model, the multimodal generative model comprising:
(a) a first level comprising n network modules, each having a plurality of layers of units; and
(b) a second level comprising m layers of units;
wherein the generative model is trained by inputting it training data comprising at least l different data modalities and wherein at least one data modality comprises chemical compound fingerprints.

2. The computer system of claim 1, wherein at least one of the n network modules comprises an undirected graph.

3. The computer system of claim 2, wherein the undirected graph comprises a restricted Boltzmann machine (RBM) or deep Boltzmann machine (DBM).

4. The computer system of claim 1, wherein at least one data modality comprises genetic information.

5. The computer system of claim 1, wherein at least one data modality comprises test results or image.

6. The computer system of claim 1, wherein a first layer of the second level is configured to receive input from a first inter-level layer of each of the n network modules.

7. The computer system of claim 6, wherein a second inter-level layer of each of the n network modules is configured to receive input from a second layer of the second level.

8. The computer system of claim 7, wherein the first layer of the second level and the second layer of the second level are the same.

9. The computer system of claim 7, wherein the first inter-level layer of a network module and the second inter-level layer of a network module are the same.

10. The computer system of claim 1, wherein n is at least 2, 3, 4, 5, 6, 7, 8, 9, 10, 15, 20, 25, 30, 35, 40, 45, 50, 60, 70, 80, 90, or 100.

11. The computer system of claim 1, wherein m is at least 1, 2, 3, 4, or 5.

12. The computer system of claim 1, wherein l is at least 2, 3, 4, 5, 6, 7, 8, 9, or 10.

13. The computer system of claim 1, wherein the training data comprises a data type selected from the group consisting of genetic information, whole genome sequence, partial genome sequence, biomarker map, single nucleotide polymorphism (SNP), methylation pattern, structural information, translocation, deletion, substitution, inversion, insertion, viral sequence insertion, point mutation, single nucleotide insertion, single nucleotide deletion, single nucleotide substitution, microRNA sequence, microRNA mutation, microRNA expression level, chemical compound representation, fingerprint, bioassay result, gene expression level, mRNA expression level, protein expression level, small molecule production level, glycosylation, cell surface protein expression, cell surface peptide expression, change in genetic information, X-ray image, MR image, ultrasound image, CT image, photograph, micrograph, patient health history, patient demographic, patient self-report questionnaire, clinical notes, toxicity, cross-reactivity, pharmacokinetics, pharmacodynamics, bioavailability, and solubility.

14. The computer system of claim 1, wherein the generative model is configured to generate values for a chemical compound fingerprint upon input of genetic information and test results.

15. The computer system of claim 1, wherein the generative model is configured to generate values for genetic information upon input of chemical compound fingerprint and test result.

16. The computer system of claim 1, wherein the generative model is configured to generate values for test results upon input of chemical compound fingerprint and genetic information.

17. A method for training a generative model, comprising
(a) inputting it training data comprising at least l different data modalities, at least one data modality comprising chemical compound fingerprints;
wherein the generative model comprises
(i) a first level comprising n network modules, each having a plurality of layers of units; and
(ii) a second level comprising m layers of units.

18. A method of generating personalized drug prescription predictions, the method comprising:
(a) inputting to a generative model a value for genetic information and a fingerprint value for a chemical compound; and
(b) generating a value for test results;
wherein the generative model comprises
(i) a first level comprising n network modules, each having a plurality of layers of units; and
(ii) a second level comprising m layers of units;
wherein the generative model is trained by inputting it training data comprising at least l different data modalities, at least one data modality comprising chemical compound fingerprints, at least one data modality comprising test results, and at least one data modality comprising genetic information; and wherein the likelihood of a patient having genetic information of the input value to have the generated test results upon administration of the chemical compound is greater than or equal to a threshold likelihood.

19. The method of claim 18, further comprising producing for the patient a prescription comprising the chemical compound.

20. The method of claim 18, wherein the threshold likelihood is at least 99%, 98%, 97%, 96%, 95%, 90%, 80%, 70%, 60%, 50%, 45%, 40%, 35%, 30%, 25%, 20%, 15%, 10%, 9%, 8%, 7%, 6%, 5%, 4%, 3%, 2%, 1%, 0.5%, or 0.1%.

21. A method of personalized drug discovery, the method comprising:
(a) inputting to a generative model a test result value and a value for genetic information; and
(b) generating a fingerprint value for a chemical compound;
wherein the generative model comprises
(i) a first level comprising n network modules, each having a plurality of layers of units; and
(ii) a second level comprising m layers of units;
wherein the generative model is trained by inputting it training data comprising at least l different data modalities, at least one data modality comprising chemical compound fingerprints, at least one data modality comprising test results, and at least one data modality comprising genetic information; and wherein the likelihood of a patient having genetic information of the input value to have the test results upon administration of the chemical compound is greater than or equal to a threshold likelihood.

22. The method of claim 21, wherein the threshold likelihood is at least 99%, 98%, 97%, 96%, 95%, 90%, 80%, 70%, 60%, 50%, 45%, 40%, 35%, 30%, 25%, 20%, 15%, 10%, 9%, 8%, 7%, 6%, 5%, 4%, 3%, 2%, 1%, 0.5%, or 0.1%.

23. A method of identifying patient populations for a drug, the method comprising:
(a) inputting to a generative model a test result value and a fingerprint value for a chemical compound; and
(b) generating a value for genetic information;
wherein the generative model comprises
(i) a first level comprising n network modules, each having a plurality of layers of units; and
(ii) a second level comprising m layers of units;
wherein the generative model is trained by inputting it training data comprising at least l different data modalities, at least one data modality comprising chemical compound fingerprints, at least one data modality comprising test results, and at least one data modality comprising genetic information; and wherein the likelihood of a patient having genetic information of the generated value to have the input test results upon administration of the chemical compound is greater than or equal to a threshold likelihood.

24. The method of claim 23, wherein the threshold likelihood is at least 99%, 98%, 97%, 96%, 95%, 90%, 80%, 70%, 60%, 50%, 45%, 40%, 35%, 30%, 25%, 20%, 15%, 9%, 8%, 7%, 6%, 5%, 4%, 3%, 2%, 1%, 0.5%, or 0.1%.

25. The method of claim 23, further comprising:
conducting a clinical trial comprising a plurality of human subjects, wherein an administrator of the clinical trial has genetic information satisfying the generated value for genetic information for at least a threshold fraction of the plurality of human subjects.

26. The method of claim 25, wherein the threshold fraction is at least at least 99%, 98%, 97%, 96%, 95%, 90%, 80%, 70%, 60%, 50%, 45%, 40%, 35%, 30%, 25%, 20%, 15%, 10%, 9%, 8%, 7%, 6%, 5%, 4%, 3%, 2%, 1%, 0.5%, or 0.1%.

27. A method of conducting a clinical trial for a chemical compound, the method comprising:
(a) administering to a plurality of human subjects the chemical compound,
wherein an administrator of the clinical trial has genetic information satisfying a generated value for genetic information for at least a threshold fraction of the plurality of human subjects and wherein the generated value for genetic information is generated according to the method of claim 23.

28. The method of claim 27, wherein the threshold fraction is at least at least 99%, 98%, 97%, 96%, 95%, 90%, 80%, 70%, 60%, 50%, 45%, 40%, 35%, 30%, 25%, 20%, 15%, 10%, 9%, 8%, 7%, 6%, 5%, 4%, 3%, 2%, 1%, 0.5%, or 0.1%.
